(19) United States
(12) Patent Application Publication
(10) Pub. No.: US 2012/0246113 A1
(43) Pub. Date: Sep. 27, 2012

(54) EMBEDDED DEVICE WITH FILE CHANGE NOTIFICATION FUNCTION AND METHOD THEREOF

(75) Inventor: CHIEN-HUA CHEN, Tu-Cheng (TW)

(73) Assignee: HON HAI PRECISION INDUSTRY CO., LTD., Tu-Cheng (TW)

(21) Appl. No.: 13/154,453

(22) Filed: Jun. 7, 2011

(30) Foreign Application Priority Data
Mar. 23, 2011 (CN) 201110070835.0

(51) Int. Cl. G06F 17/30

(52) U.S. Cl. 707/613; 707/E17.005

(57) ABSTRACT

An embedded device includes a first central processing unit (CPU), a second CPU, a first operating system (OS) and a second OS. A server of a network configuration file system (NFS) storing configuration files is associated with the first OS. A client of the NFS sharing the configuration files stored in the server is associated with the second OS. The second OS sends a monitoring instruction to the first OS to monitor whether the configuration files shared by the second OS are modified. The first OS monitors whether the configuration files shared by the second OS are modified on the first OS according to the monitoring instruction, and generates an update notification to the second OS when the configuration files shared by the second OS are modified. The second OS further acquires update content according to the update notification to update the shared configuration files on the second OS.

### BACKGROUND

1. Technical Field

The present disclosure relates to embedded devices and, particularly, to an embedded device with a file change notification function and a method for file change notification.

2. Description of Related Art

Embedded devices may include multiple central processing units (CPUs), each of which may correspond to an operating system (OS), such as WINDOWS or LINUX. Each OS may have one configuration file with the same content across the OSes to be executed by a corresponding CPU. If a configuration file is modified in one OS, the changed configuration file must be copied to the other OSes synchronously. However, the configuration file synchronization is complex and is not easy to accomplish.

### BRIEF DESCRIPTION OF THE DRAWINGS

FIG. 1 is a schematic diagram of an embodiment of an embedded device with a file change notification function.

FIG. 2 is a flowchart of an embodiment of a method for file change notification function implemented by the embedded device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a program language. The modules described herein may be implemented as either software and/or hardware modules and may be stored in any type of computer-readable medium or other storage device.

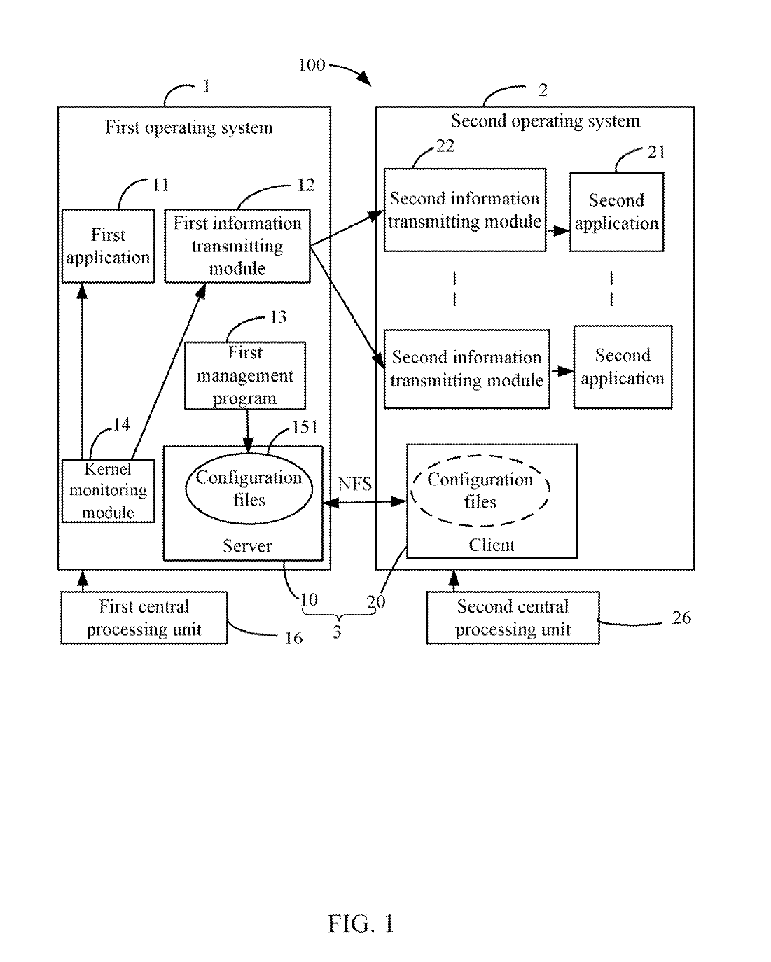

Referring to FIG. 1, an embedded device 100 with a file change notification function is illustrated. The embedded device 100 includes a first operating system (OS) 1 (such as, WINDOWS) and a second OS 2 (such as, LINUX). The first OS 1 is executed by a first central processing unit (CPU) 16, and the second OS 2 is executed by a second CPU 26. The first OS 1 and the second OS 2 share the configuration files of each other via a network configuration file system (NFS) 3. In one embodiment, the NFS 3 includes a server 10 and a client 20. The server 10 is associated with the first OS 1, and is configured for storing a number of configuration files 151 which can be shared by the client 20 which is associated with the second OS 2. The configuration files 151 records the configuration information of the first CPU, the second CPU, and I/O ports. In other embodiments, the server 10 of the NFS 3 can be associated with the second OS 2, and the client 20 of the NFS 3 can be associated with the first OS 1.

The first OS 1 includes a first application 11, a first information transmitting module 12, a kernel monitoring module 14, and a first management program 13.

The first management program 13 is configured for providing a first user interface for a user to modify the configuration information of the configuration files 151 on the first OS 1.

The second OS 2 includes at least a second information transmitting module 22 and at least one second application 21.

The second information transmitting module 22 is configured for sending a monitoring instruction to the first OS 1.

The kernel monitoring module 14 is configured for monitoring whether the configuration files 151 shared by the second OS 2 are modified by the first management program 13 according to the monitoring instruction.

The first information transmitting module 12 is configured for transmitting an update notification to the second OS 2 when the kernel monitoring module 14 monitors that the configuration files shared by the second OS 2 are modified by the first management program 13. The first application 11 is configured for acquiring update content to update the configuration files 151 stored in the server when the kernel monitoring module 14 monitors that the configuration files shared by the second OS 2 are modified.

The second information transmitting module 22 is further configured for receiving the update notification from the first information transmitting module 12. The second application 21 is configured for acquiring the update content according to the received update notification to update the configuration files 151 on the second OS 2.

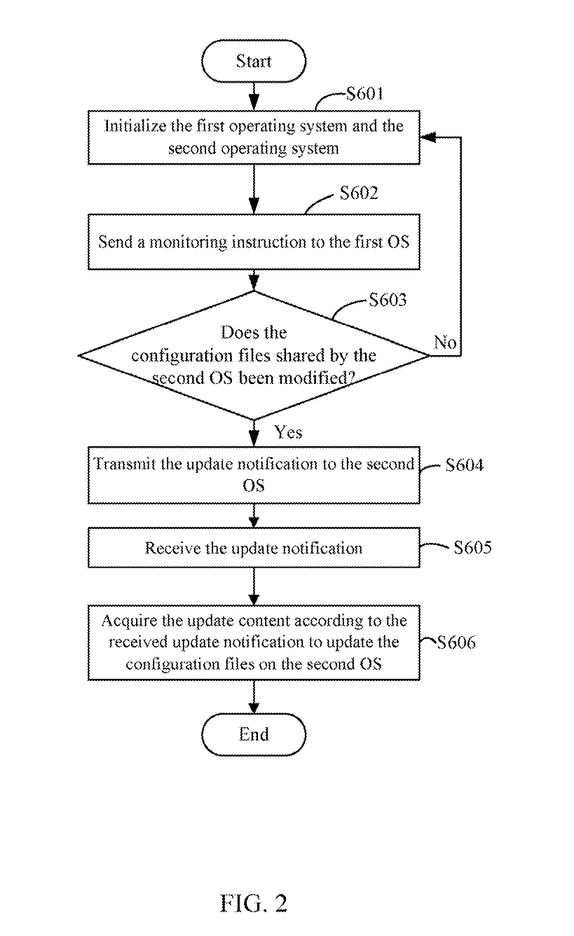

FIG. 2 is a flowchart of one embodiment of a method with a file change notification function implemented by the embedded device of FIG. 1.

In step S601, the first CPU 16 initializes the first OS 1 and the second CPU 26 initializes the second OS 2.

In step S602, the second information transmitting module 22 sends a monitoring instruction to the first OS 1.

In step S603, the kernel monitoring module 14 monitors whether the configuration files shared by the second OS 2 are modified by the first management program 13 according to the monitoring instruction, if yes, the procedure goes to step S604, if no, the procedure goes to step S601.

In step S604, the first information transmitting module 12 transmits the update notification to the second OS 2.

In step S605, the second information transmitting module 22 receives the update notification from the first information transmitting module 12.

In step S606, the second application 21 acquires the update content according to the received update notification to update the configuration files on the second OS 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An embedded device with a file change notification function, comprising:
a first central processing unit (CPU), and a second CPU;
a first operating system (OS) to be executed by the first CPU, wherein a server of a network configuration file system (NFS) storing a plurality of configuration files is associated with the first OS; and
a second OS to be executed by the second CPU, wherein a client of the NFS sharing the configuration files stored in the server is associated with the second OS;
the second OS being configured to send a monitoring instruction to the first OS to monitor whether the configuration files shared by the second OS are modified;
the first OS being configured to monitor whether the configuration files shared by the second OS are modified according to the monitoring instruction, and generate an update notification to the second OS when the configuration files shared by the second OS are modified;
the second OS being further configured to acquire update content according to the update notification to update the shared configuration files.

2. The embedded device as described in claim 1, wherein the first OS comprises a first management program which is configured to provide a user interface to modify the configuration files stored in the server of the NFS.

3. The embedded device as described in claim 1, wherein the first OS further comprises a first application which is configured to acquire the update content to update the configuration files on the first OS when the configuration files shared by the second OS are modified.

4. The embedded device as described in claim 1, wherein the second OS comprises a second application which is configured to acquire the update content according to the update notification to update the configuration files shared by the second OS on the second OS.

5. The embedded device as described in claim 1, wherein the configuration files stored in the server record configuration information of the first CPU, the second CPU, and I/O ports.

6. A method for file change notification function, comprising:
initializing a first operating system (OS) being executed by a first central processing unit (CPU) and a second OS being executed by a second CPU, wherein a server of a network configuration file system (NFS) storing a plurality of configuration files is associated with the first OS; and a client of the NFS sharing the configuration files stored in the server is associated with the second OS;
sending a monitoring instruction to the first OS to monitor whether the configuration files shared by the second OS are modified on the first OS;
monitoring whether the configuration files shared by the second OS are modified on the first OS according to the monitoring instruction, and generating an update notification to the second OS when the configuration files shared by the second OS are modified on the first OS; and
acquiring update content according to the update notification to update the shared configuration files on the second OS.

7. The method as described in claim 6, further comprising:
monitoring whether the configuration files stored in the server of the NFS are modified by a first management program.

8. The method as described in claim 6, further comprising:
acquiring the update content to update the configuration files on the first OS when the configuration files shared by the second OS are modified.

9. The method as described in claim 6, further comprising:
acquiring the update content according to the update notification to update the configuration files shared by the second OS on the second OS.

10. The method as described in claim 6, wherein the configuration files stored in the server records configuration information of the first (CPU), the second CPU and I/O ports.
